(19) United States
(12) Patent Application Publication
(10) Pub. No.: US 2015/0121012 A1
(43) Pub. Date: Apr. 30, 2015

(54) METHOD AND APPARATUS FOR PROVIDING DEDICATED ENTRIES IN A CONTENT ADDRESSABLE MEMORY TO FACILITATE REAL-TIME CLIENTS

(71) Applicant: Advanced Micro Devices, Inc., Sunnyvale, CA (US)

(72) Inventor: Wade K. Smith, Sunnyvale, CA (US)

(21) Appl. No.: 14/516,186

(22) Filed: Oct. 16, 2014

Related U.S. Application Data
(60) Provisional application No. 61/897,714, filed on Oct. 30, 2013.

(51) Int. Cl. G06F 12/12; G06F 12/08

(52) U.S. Cl. CPC G06F 12/122; G06F 12/0848; G06F 2212/282; G06F 2212/69
USPC 711/129

(57) ABSTRACT

A device and method for partitioning a cache that is expected to operate with at least two classes of clients (such as real-time clients and non-real-time clients). A first portion of the cache is dedicated to real-time clients such that non-real-time clients are prevented from utilizing said first portion.

### PRIORITY

The present application is a non-provisional application of U.S. Provisional Application Ser. No. 61/891,714, titled METHOD AND APPARATUS FOR PROVIDING DEDICATED ENTRIES IN A CONTENT ADDRESSABLE MEMORY TO FACILITATE REAL-TIME CLIENTS, filed Oct. 30, 2013, the disclosure of which is incorporated herein by reference and the priority of which is hereby claimed.

### FIELD OF THE DISCLOSURE

The present disclosure is related to methods and devices for improving performance of hierarchical memory systems. The present disclosure is more specifically related to methods and devices for improving memory translations in cache that do not tolerate latency well.

### BACKGROUND

The ever-increasing capability of computer systems drives a demand for increased memory size and speed. The physical size of memory cannot be unlimited, however, due to several constraints including cost and form factor. In order to achieve the best possible performance with a given amount of memory, systems and methods have been developed for managing available memory. One example of such a system or method is virtual addressing, which allows a computer program to behave as though the computer's memory was larger than the actual physical random access memory (RAM) available. Excess data is stored on hard disk and copied to RAM as required.

Virtual memory is usually much larger than physical memory, making it possible to run application programs for which the total code plus data size is greater than the amount of RAM available. This process of only bringing in pages from a remote store when needed is known as “demand paged virtual memory”. A page is copied from disk to RAM (“paged in”) when an attempt is made to access it and it is not already present. This paging is performed automatically, typically by collaboration between the central processing unit (CPU), the memory management unit (MMU), and the operating system (OS) kernel. The application program is unaware of virtual memory; it just sees a large address space, only part of which corresponds to physical memory at any instant. The virtual address space is divided into pages. Each virtual address output by the CPU is split into a (virtual) page number (the most significant bits) and an offset within the page (the N least significant bits). Each page thus contains 2^{N} bytes. The offset is left unchanged and the MMU maps the virtual page number to a physical page number. This is recombined with the offset to give a physical address that indicates a location in physical memory (RAM). The performance of an application program depends on how its memory access pattern interacts with the paging scheme. If accesses exhibit a lot of locality of reference, i.e. each access tends to be close to previous accesses, the performance will be better than if accesses are randomly distributed over the program's address space, thus requiring more paging. In a multitasking system, physical memory may contain pages belonging to several programs. Without demand paging, an OS would need to allocate physical memory for the whole of every active program and its data, which would not be very efficient.

In general, the overall performance of a virtual memory/page table translation system is governed by the hit rate in the translation lookaside buffers (TLBs). A TLB is a table that lists the physical address page number associated with each virtual address page number. A TLB is typically used as a level 1 (L1) cache whose tags are based on virtual addresses. The virtual address is presented simultaneously to the TLB and to the cache so that cache access and the virtual-to-physical address translation can proceed in parallel (the translation is done “on the side”). If the requested address is not cached, the physical address is used to locate the data in memory that is outside of the cache. This is termed a cache “miss”. If the address is cached, this is termed a cache “hit”.

Certain computing operations have increased potential for a cache miss to negatively impact the perceived quality of operations being performed thereby. In general, such operations include those that are directly perceived by a user. By way of example, streaming video and audio operations, if delayed (due to having to perform a fetch due to a cache miss or otherwise) potentially result in “skips” or “freezes” in the perceived audio or video stream. Moreover, streaming “real-time” applications are particularly susceptible to having a cache miss result in an unacceptable user experience. Whereas cache misses are generally undesirable and result in slower perceived computing times, misses have the increased ability to negatively affect the quality of the output in real-time applications. Accordingly, what is needed is a system and method that reduces the likelihood of such real-time operations encountering a cache miss that diminishes the perceived output thereof.

### BRIEF DESCRIPTION OF THE DRAWINGS

FIG. 1 is a diagram showing exemplary architecture of a system employing a cache system according to an embodiment of the present disclosure;

FIG. 2 is a flowchart showing operation of the system of FIG. 1 according to one embodiment of the present disclosure;

FIG. 3 is a flowchart showing operation of the system of FIG. 1 according to another embodiment of the present disclosure;

FIG. 4 is a flowchart showing operation of the system of FIG. 1 according to yet another embodiment of the present disclosure;

### DETAILED DESCRIPTION OF EMBODIMENTS

In an exemplary and non-limited embodiment, aspects of the invention are embodied in a method of partitioning a cache that is expected to operate with at least two classes of clients such as real-time clients and non-real-time clients. The method includes dedicating a first portion of the cache to real-time clients such that non-real-time clients are prevented from utilizing said first portion.

In another example, a memory controller is provided including a determination module operable to determine when a memory request is being received from a client of a first class and when a memory request is being received from a client of a second class. The controller is operable to only permit clients of the first class to utilize a first section of a memory that is segmented into at least two sections, including: the first section dedicated to clients of the first class; and a second section dedicated to clients not of the first class.

In still another example, a computer readable medium is provided that contains non-transitory instructions thereon, that when interpreted by at least one processor cause the at least one processor to dedicate a first portion of a cache to clients in a first class of at least two classes such that clients not in the first class are prevented from utilizing said first portion.

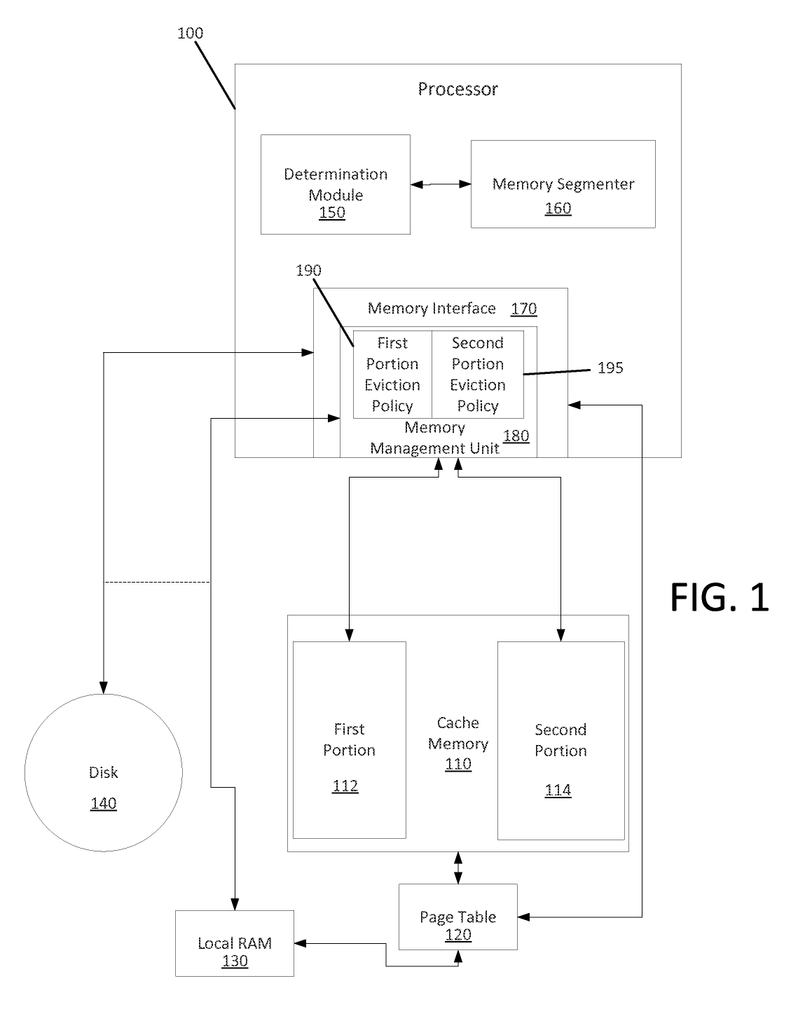

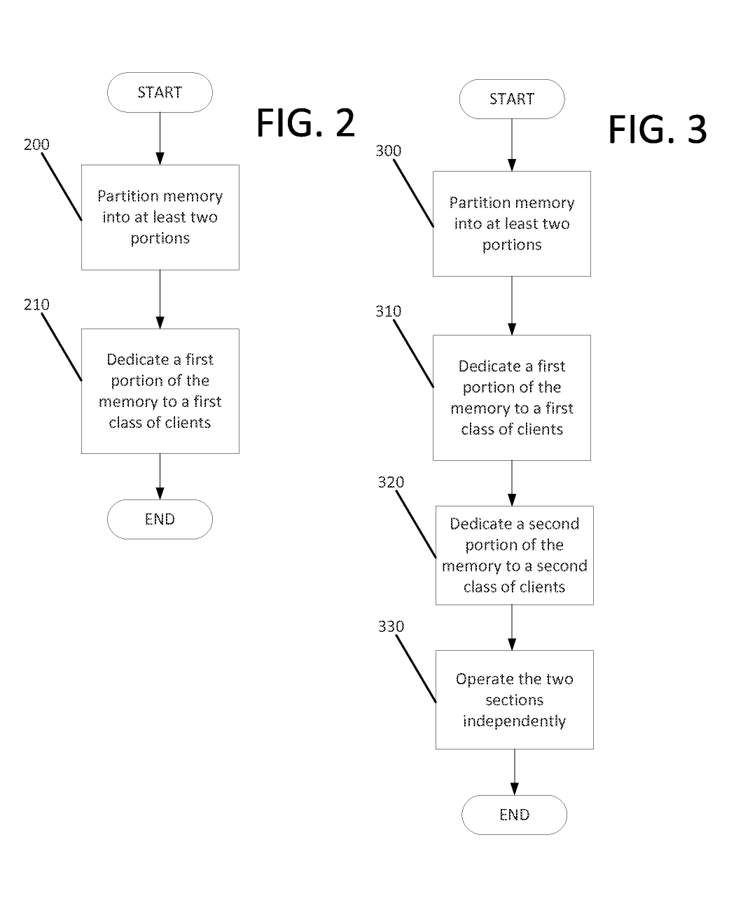

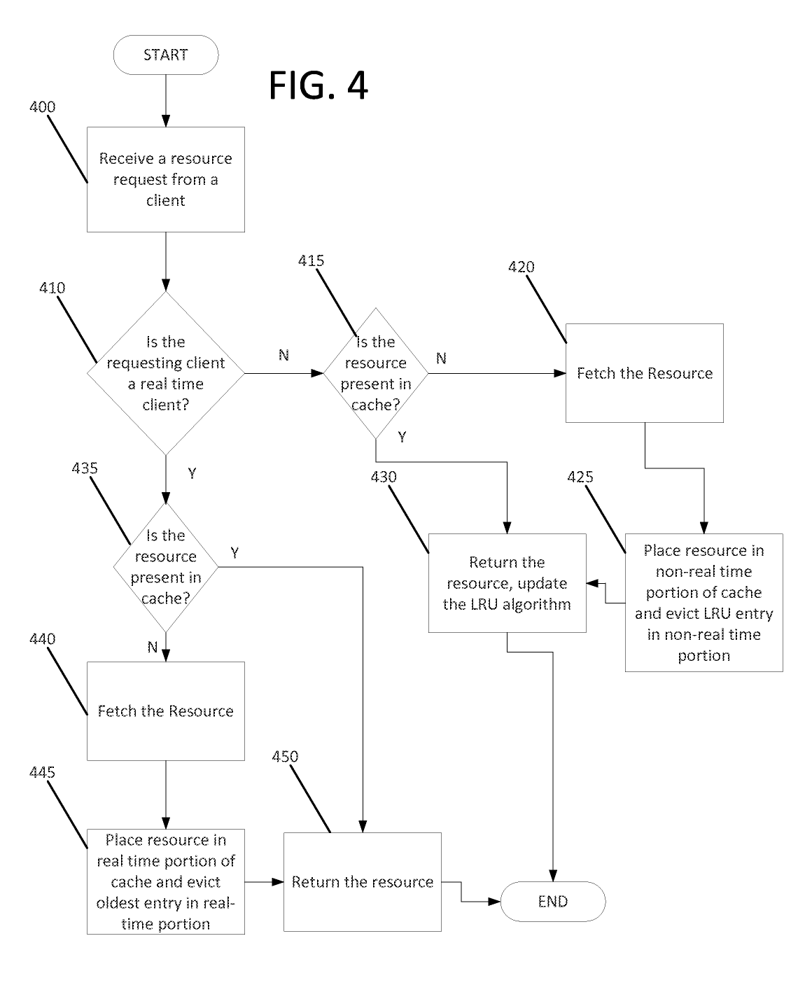

FIG. 1 shows a computing system that includes processor 100, cache memory 110, page table 120, local RAM 130, and non-volatile memory disk 140. Processor 100 includes determination module 150, memory segmenter 160, memory interface 170 and memory management unit (MMU) 180. MMU 180 includes memory eviction policies 190, 195.

Determination module 150 sees inputs, such as Page Table Entries (PTEs) and sees client ID's associated with each PTE. Client ID's are used by determination module 150 to classify and direct the obtained PTE into one of at least two classes. In the presently described embodiment, determination module 150 uses client IDs to classify the PTE as a function of the client requesting the PTE as being a real-time client (and thus a real-time PTE, likely a client for whom the output is directly perceived by a user such that the quality of the output is dependent upon the timely operation thereof), or a non-real-time client.

Memory segmenter 160 operates to segment cache 110 into at least two portions (112, 114). Cache memory 110 is shown as being separate from processor 100. However, it should be appreciated that embodiments are envisioned where cache 110 is on-board memory that is integrated with processor 100. Cache memory 110 is illustratively content addressable memory (CAM). Cache memory 110 is sized as a power of two entries (2, 4, 8, etc) which is 64 entries for purposes of this exemplary disclosure. Memory segmenter 160 is operable to reserve or set-aside a portion of cache memory 110 for exclusive use by one or a set of operations being conducted by processor 100. In the present example, memory segmenter 160 is only allowed to restrict one-half of the available size of cache 110. The remaining (at least) half of cache 110 is available generally.

Memory interface 170 is a generic identifier for software and hardware that allows and controls processor 100 interaction with cache 110, ram 130, and non-volatile memory disk 140. Memory interface 170 includes MMU 180. MMU 180 is a hardware component responsible for handling accesses to memory requested by processor 100. MMU 180 is responsible for translation of virtual memory addresses to physical memory addresses (address translation via PTEs or otherwise) and cache control. As part of cache control, MMU 180 maintains a cache eviction policy for cache 110. As noted, in the present disclosure, cache 110 is segmented into two portions. Accordingly, MMU 180 has separate cache eviction policies (190, 195) for respective portions (112, 114).

In the present embodiment, cache 110 is Level 1 cache (L1) operating as a memory translation buffer such that PTEs obtained from page table 120 are stored therein. Page table 120 is stored in Level 2 cache (L2). However, it should be appreciated that this use is merely exemplary and the concepts described herein are readily applicable to other uses where segmentation of cache 110 is desirable. As previously noted, memory segmenter 160 has designated two portions of cache 110. In the present embodiment, the segmentation creates first (real-time) portion 112 and second (non-real-time) portion 114.

First portion 112 is a portion created by memory segmenter 160 that, in the present example, is half of cache 110. Accordingly, given a 64 slot size for cache 110 (the size will be a power of 2) first portion 112 is 32 slots (or smaller). The actual size of the cache 110 (TLB CAM) is fixed in hardware. However, the programmable register control is able to adjust the apparent size. Given the apparent size, memory segmenter 160 then sets the size of the reserved portion (first portion 112).

As should be appreciated in cache systems, when a requested address is present in a certain level of cache, that is considered a cache hit that causes the resource to be returned to the requesting agent and causes updates to any heuristic in the level of cache regarding the resource's use, if such heuristics are used. If the requested resource is not present at the queried level of cache, then a deeper level of memory is consulted to obtain the resource. In such a manner, local RAM 130 and disk 140 are potentially queried.

Having generally described the elements of the system, an exemplary use case will not be described. Processor 100 is being utilized by multiple clients. A first client is a real-time client such as a video playback client. A second client is a non-real-time client, such as a texture control client.

Memory segmenter 160 observes the operations and traffic and partitions cache 110, blocks 200, 300, to allocate an amount of space therein as dedicated for first portion 112, blocks 210, 310. When determining how much memory to allocate to first portion 112, memory segmenter 160 takes into account things such as whether any real-time clients are currently being executed, how many real-time clients are currently being executed, how many lookup calls are being generated by real-time clients, etc. The balance of cache 110 forms second portion 114. Second portion 114 is dedicated to non-real-time clients, block 320.

When the first client requests a resource, that request is received, block 400. The request is then checked by determination module 150 to determine if it came from a real-time client, block 410. Regardless of whether it is a real-time request, if the resource is present in cache 110, block 415, 435, it is provided to the requesting client, block 430, 450. If the requesting client was a non-real-time client, then the LRU algorithm is updated to note the use of the resource, block 430.

If the requested resource is not present, a cache miss, then page table 120 is queried for the resource, a fetch, block 420, 440. (Similarly, additional layers of memory are queried for the resource until it is obtained.)

MMU 180, informed by determination module 150, then places the returned resource (PTE) into one of first portion 112, and second portion 114. Resources requested by real-time clients are placed within first portion 112. Resources requested by non-real-time clients are placed within second portion 114.

Once the system has been operating for more than the shortest of times, each level of cache fills up as it stores returned resources. Once a cache is full (all available storage slots are occupied, also referred to as being “warmed up”) in order to place a new resource within the cache, other resources must be removed or allowed to expire therefrom. Exactly which entries are “kicked out” or “evicted” is determined by a cache replacement algorithm. In the present exemplary embodiment where the resources are memory pages, such replacement algorithms are referred to a page replacement algorithms. Pages being placed into cache are said to be “paged in” and pages being removed from cache are “paged out.”

First portion 112 and second portion 114 of cache 110 are separately filled. Accordingly, a separate roster and algorithm for determining page outs from the respective portions 112, 114 are likewise maintained. Because each portion 112, 114 independently processes page ins and page outs, block 330, there is no requirement that they both follow the same algorithm or reasoning by which the decision on page outs is made. These separate page out policies are first portion eviction policy 190 and second portion eviction policy 195.

In the present exemplary embodiment, first portion eviction policy 190 follows a first-in, first-out (FIFO) policy, block 445. First portion 190 is the real-time portion. Accordingly, the FIFO policy presents an increased probability of generating cache hits therefrom for real-time operations. In one embodiment, first portion 112 operates as a ring buffer.

Second portion eviction policy 195 follows a least-recently-used (LRU) policy where the entry that was last accessed the longest time ago is paged out, block 425. Only new entries requested by real-time operations can evict other real-time requests from cache 110. Similarly, only new entries requested by non-real-time operations can evict other non-real-time requests from cache 110. Once present in cache 110, the requested resource is returned to the requesting client, block 430, 450.

Accordingly, a system is provided that allows for separate mutually-exclusive portions within a cache. The system further provides that the contents of each section can be independently administered. Such independent administration allows separation of operations such that each operation is able to be matched up with a cache that is administered so as to increase the chances of cache hits therefor and thereby increase performance.

Additionally, first portion 112 is available for pre-fetching/pre-loading for real time clients. When the space within first portion 112 is greater than or equal to the a working set utilized by the presently executing real-time clients, the prefetching provides yet further resources to reduce or eliminate misses for real-time clients. In one embodiment, the pre-fetching is performed via dedicated client requests that are targeted to reference specific PTEs.

The software operations described herein can be implemented in hardware such as discrete logic fixed function circuits including but not limited to state machines, field programmable gate arrays, application-specific circuits or other suitable hardware. The hardware may be represented in executable code stored in non-transitory memory such as RAM, ROM or other suitable memory in hardware descriptor languages such as, but not limited to, RTL and VHDL or any other suitable format. The executable code when executed may cause an integrated fabrication system to fabricate an IC with the operations described herein.

Also, integrated circuit design systems/integrated fabrication systems (e.g., work stations including, as known in the art, one or more processors, associated memory in communication via one or more buses or other suitable interconnect and other known peripherals) are known that create wafers with integrated circuits based on executable instructions stored on a computer-readable medium such as, but not limited to, CDROM, RAM, other forms of ROM, hard drives, distributed memory, etc. The instructions may be represented by any suitable language such as, but not limited to, hardware descriptor language (HDL), Verilog or other suitable language. As such, the logic, circuits, and structure described herein may also be produced as integrated circuits by such systems using the computer-readable medium with instructions stored therein. For example, an integrated circuit with the aforedescribed software, logic and structure may be created using such integrated circuit fabrication systems. In such a system, the computer readable medium stores instructions executable by one or more integrated circuit design systems that cause the one or more integrated circuit design systems to produce an integrated circuit.

The above detailed description and the examples described therein have been presented for the purposes of illustration and description only and not for limitation. For example, the operations described may be done in any suitable manner. The method may be done in any suitable order still providing the described operation and results. It is therefore contemplated that the present embodiments cover any and all modifications, variations or equivalents that fall within the spirit and scope of the basic underlying principles disclosed above and claimed herein. Furthermore, while the above description describes hardware in the form of a processor executing code, hardware in the form of a state machine or dedicated logic capable of producing the same effect are also contemplated.

What is claimed is:

1. A method of partitioning a cache to operate with at least two classes of clients including:
dedicating a first portion of the cache to clients in a first class of the at least two classes such that clients not in the first class are prevented from utilizing said first portion.

2. The method of claim 1, wherein a second portion of the cache is provided such that clients of the first class are prevented from utilizing the second portion.

3. The method of claim 1, wherein the clients of the first class are required to use the first portion of the cache.

4. The method of claim 1, wherein the cache includes a second portion, the method further including providing a first cache replacement policy for the first portion and providing a second cache replacement policy for the second portion, the first and second cache replacement policies independently governing the first and second caches, respectively.

5. The method of claim 4, wherein the first cache replacement policy is different than the second cache replacement policy.

6. The method of claim 4, wherein one of the first and second cache replacement policies defines first-in-first-out based replacement policy and one of the first and second cache replacement policies defines a least-recently-used based replacement policy.

7. The method of claim 1, wherein the cache provides a translation look-aside buffer.

8. The method of claim 1, further including defining the first class of clients as those performing real-time operations whose output is expected to be provided to an output device for perception by a user.

9. The method of claim 8, wherein the real-time operations are related to presentation of a streaming media signal.

10. The method of claim 1, further including,
determining whether a first memory request is being received from a client of the first class or whether the first memory request is being received from a client other than those of the first class;
requiring that the first memory request utilize the first portion of memory when the first memory request is received from a client of the first class; and
requiring that the first memory request utilize a second memory portion when the first memory request is received from a client other than those of the first class.

11. A memory controller including:
a determination module operable to determine when a memory request is being received from a client of a first class and when a memory request is being received from a client of a second class,
the controller operable to only permit clients of the first class to utilize a first section of a memory that is segmented into at least two sections, including:
the first section dedicated to clients of the first class; and
a second section dedicated to clients not of the first class.

12. The controller of claim 11, wherein the clients of the first class are those clients performing operations that are presented to an output such that they can be perceived by a user in real-time.

13. The controller of claim 11, wherein the clients provide at least one of audio and video outputs.

14. The controller of claim 11, wherein the clients of the first class are required to use the first portion of the memory.

15. The controller of claim 11, wherein the memory is a cache, the first memory section is governed by a first replacement policy and the second memory section is governed by a second replacement policy, the first and second replacement policies independently governing the first and second memories.

16. The controller of claim 15, wherein the first cache replacement policy is different than the second cache replacement policy.

17. The controller of claim 15, wherein one of the first and second cache replacement policies defines first-in-first-out based replacement policy and one of the first and second cache replacement policies defines least-recently-used based replacement policy.

18. The controller of claim 11, wherein the controller is part of a computing device.

19. A computer readable medium containing non-transitory instructions thereon, that when interpreted by at least one processor cause the at least one processor to:
dedicate a first portion of a cache to clients in a first class of at least two classes such that clients not in the first class are prevented from utilizing said first portion.

20. The computer readable medium of claim 19, wherein the cache includes a second portion, and the instructions further cause the processor to establish a first cache replacement policy for the first portion and establish a second cache replacement policy for the second portion, the first and second cache replacement policies independently governing the first and second caches, respectively.
